(19) United States
(12) Patent Application Publication
(10) Pub. No.: US 2009/0247133 A1
(43) Pub. Date: Oct. 1, 2009

(54) INFORMATION COMMUNICATION METHOD

(75) Inventors: Eric Holmen, Irvine, CA (US); Gregory Wexler, Irvine, CA (US)

Correspondence Address: DLA PIPER US LLP, 1999 AVENUE OF THE STARS, SUITE 400, LOS ANGELES, CA, 90067-6023, US

(73) Assignee: SMARTREPLY, INC., IRVINE, CA (US)

(21) Appl. No.: 12/408,639

(22) Filed: Mar. 20, 2009

Related U.S. Application Data
(60) Provisional application No. 61/039,221, filed on Mar. 25, 2008.

(51) Int. Cl. H04M 3/42; H04W 4/20

(52) U.S. Cl. 455/414.1; 455/466

(57) ABSTRACT

The present system provides a method for exchanging contact information that can be accomplished easily using a telephone or SMS texting device. A first user maintains a database of contact information at a repository. Upon meeting a second person, the first person gives a unique ID to the second person, who texts the unique ID to a SMS text address of the repository. The repository responds by (a) providing a return text to the second person with the contact information of the first person, which can be automatically added to a contact database of the second person, and/or (b) initiates a phone call to the second person with a pre-recorded message from the first person providing the contact information. In one embodiment, the follow up phone call includes advertising and/or an opt-in offer.

### BACKGROUND OF THE SYSTEM

When two people meet they often want to exchange contact information so that they can facilitate future communication. In the past, this information exchange has been accomplished by the exchange of business cards. This system required each party to maintain some file of contacts where the business card, or the information on the business card, is transferred for future reference.

Another technique for exchanging information is to do so electronically. Certain PDA devices permit infrared or wireless communication between devices, allowing the information exchange to be accomplished in paperless manner. Although this system can be useful, it requires that both parties have compatible systems for sending and receiving the data. When implemented, the contact information can be automatically placed into a contact database.

Another current technique for exchanging information is via email. A so-called “v-card” or virtual card, can be attached to an email message and forwarded to another party or parties. In practice, at least one party will communicate an email address to the other party, who can then initiate an exchange of contact information over email. As above, the v-card can be automatically added to a contact database by the recipient.

Another method is to provide an IM (instant messaging) address of one or both parties and to use IN to exchange contact information electronically.

A disadvantage of these systems is the need to delay the exchange of contact information to a later time when the proffered email or IM address can be utilized to execute the exchange. The alternative is to write the information down and then re-enter it into a contact database. Another disadvantage is that many people do not carry computers (or at least active computers) around with them in most social situations where the exchange of contact information is most likely or most natural.

### SUMMARY OF THE SYSTEM

The present system provides a method for exchanging contact information that can be accomplished easily using a telephone or SMS texting device. A first user maintains a database of contact information at a repository. The information is identified by a unique ID comprising a keyword, character string, or user name. Upon meeting a second person, the first person gives the unique. ID to the second person, who texts the unique ID to a SMS text address of the repository. The repository responds by (a) providing a return text to the second person with the contact information of the first person, which can be automatically added to a contact database of the second person, and/or (b) initiates a phone call to the second person with a pre-recorded message from the first person providing the contact information. Either way, the second person now has a stored version of the contact information of the first person. In one embodiment, the follow up phone call includes advertising and/or an opt-in offer. In another embodiment, the follow up message does not include any contact information but invites the second party to text to the repository. This allows a more anonymous communication method.

### BRIEF DESCRIPTION OF THE DRAWINGS

FIG. 1 is a flow diagram illustrating set up of contact information in an embodiment of the system.

FIG. 2 is a flow diagram illustrating operation of an embodiment of the system.

FIG. 3 is a flow diagram illustrating an optional additional message in the system.

FIG. 4 is a flow diagram illustrating the operation of the system in connection with a real property listing.

FIG. 5 is a flow diagram illustrating the operation of the system in a credit embodiment.

FIG. 6 is an example computer embodiment for implementing the system.

### DETAILED DESCRIPTION OF THE SYSTEM

The system encourages the easy and rapid communication of contact and other information between parties. In the description below, the system is discussed in relation to the exchange of personal contact information. However, the system is not limited to such information, and may be used to exchange any desired type of information. For example, the system may be used to provide real estate listing information, credit information, and the like.

In one embodiment, a party may determine the nature, amount, and type of information to be exchanged depending on the nature of the other party and/or the nature of the relationship between the parties. A person may be willing to give more or less information depending on a number of factors, including whether the relationship is personal, business, vendor, or some other type of relationship. The system permits the user to set up a plurality of records, so that that a user can determine which record to provide to an other party.

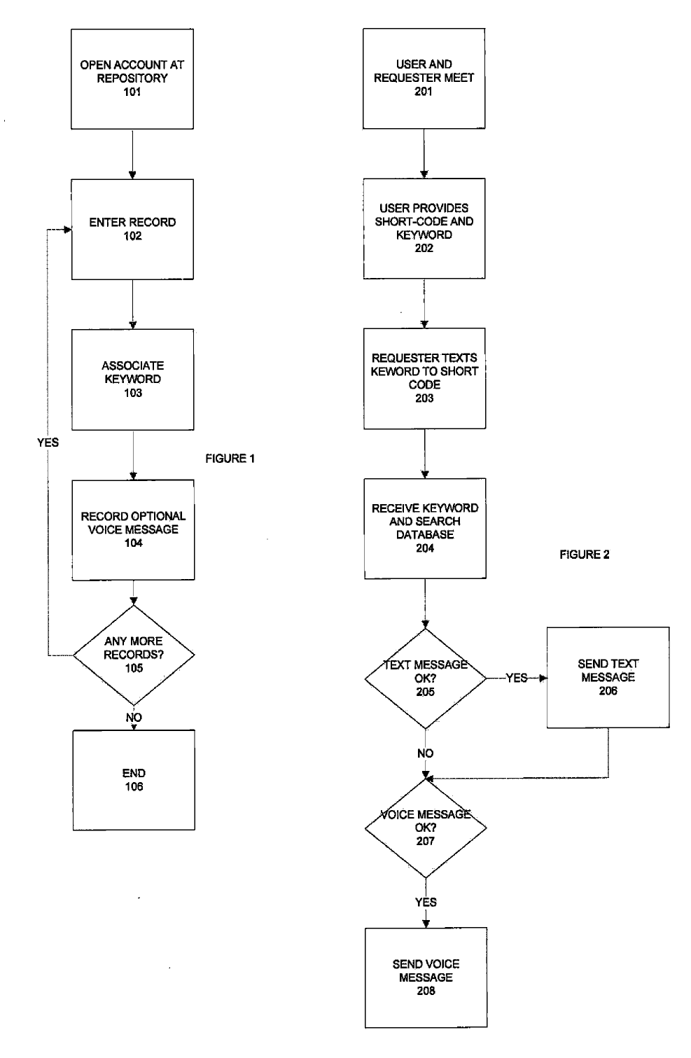

The operation of an embodiment of the system is illustrated in FIG. 1. At step 101 a user opens an account at the contact information repository. This can be accomplished via the internet, via voice application, text, or any other suitable method. The account may be associated with a short-code. At step 102 the user enters a record containing information that the user wishes to make available to other parties. In one embodiment, the record consists of contact information that the user desires to make available. However, other information may be placed in a record without departing from the scope of the system.

When the record is contact information, the data may include telephone number, physical address, email account information, IM username information, text addresses, etc. At step 103 the user associates a keyword with the record. In one embodiment, a user account has one short-code and a plurality of keywords that may be texted to that short-code, each keyword retrieving one of the records stored in the system. In other embodiments, a user may have a plurality of short-codes, each associated with one or more records.

At step 104 the user may record a voice message and elect to have that voice message call each requester when the corresponding record in the repository is accessed. This may be in addition to, or in lieu of, providing electronic transmission of the user's contact information. The system provides the user the ability to choose what response is provided by the system in response to a keyword, voice and text, text only, or voice only.

The system also permits the user to nest a plurality of options in each response, so that further replies by the other party may result in additional information being provided from the same or other records.

In one optional embodiment, the information can be associated with different identifiers or organized in different tiers or strata depending on the intended recipient of the information. For example, there may be a “business” category with work related information only. There may also be a “personal” category that includes more (or even all) information. Any number of categories may be defined so that the user can determine the amount and type of information to communicate to a recipient.

System Operation

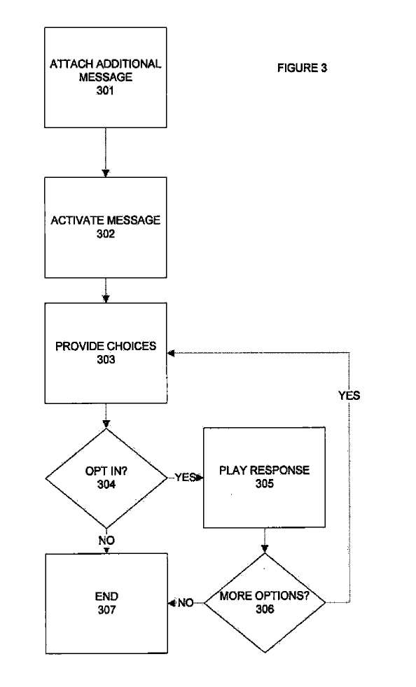

FIG. 2 illustrates the operation of an embodiment of the system where a requester accesses the user's contact information. At step 201 the requester and user meet and the requester indicates a desire to have the user's contact information. At step 202 the user provides a keyword and short-code to the requester. At step 203 the requester texts the keyword to the short-code in an SMS message.

At step 204 the short-code server receives the SMS message and searches its repository for handling instructions. At step 205 it is determined if a text reply is authorized by the user. If so, the text message containing contact information is sent at step 206. After step 206 or if at text message was not authorized, at step 207 the system determines if a pre-recorded automated voice message has been prepared and is authorized. If so, the system calls the requesters phone and provides the pre-recorded automated voice message at step 208. The SMS message received has determined when a voice reply is appropriate. The server from the SMS systems send a trigger and identifier to send a specific message ID to the voice servers. The ‘dialers’ or ‘VoIP’ or ‘SIP’ on the voice system which connects to the voice telephony then dials and delivers the message. This message may be entirely pre-recorded or it may use text-to-speech technology.

When the requester receives the contact information in text form, it is in a format that is suitable for automatic inclusion in a contact information database.

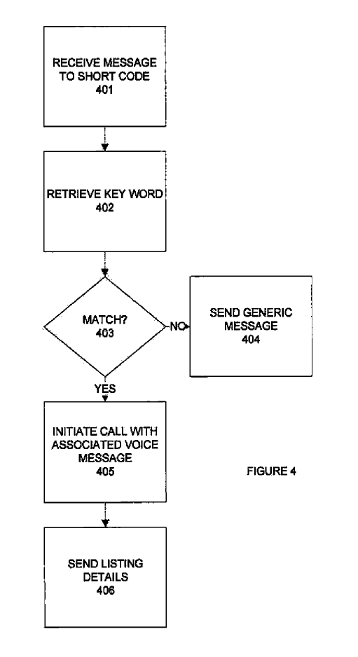

FIG. 3 illustrates an alternate embodiment of the system that is optionally used when a pre-recorded automated voice message is transmitted to the requester. If the user picks up the phone and receives the voice message, then they may interact with the system as in a traditional IVR system. This could include messages such as “Thank you for requesting my contact information. My contact information has been forwarded to you in a message (or email or by some other means).

In addition, there may be additional options available. At step 301 the system attaches an additional message to the automated message. This additional message is activated at step 302 during or after the playing of the user's pre-recorded message. This message may be, for example, “For more information about me or a demo of my company's products, press 1 now, or if you would like to connect directly to me, press 2 now.” This is given by way of example only, and other messages and choices can be provided. At step 303 the system provides the choices to the user and invites opt-in by some method. This method may be via a key touch, a voice command, or by some other means. At decision block 304 it is determined if the user has opted in.

If so, the system proceeds to step 305 and provides the requested response. In some cases, the response may be initiated via the phone call, or it may be some other action such as the sending of an email, SMS message, or some other action, virtual or physical, in response to the opt-in. At decision block 306 it is determined if there are more options. The system is such that there can be any number of nested options for the user. If so, the system returns to step 303, provides the choices and then continues as before. If there are no more options at decision block 306, or if the user does not opt-in at decision block 304, the system ends at step 307.

If the user does not answer the phone, then a voice message is delivered to their voice mail box in one embodiment of the system.

Real Estate

In one embodiment, the system is used to provide information about real estate. A seller or agent uses the system to prepare information about a particular property. The information is associated with a short-code and a key word. The short-code and key word may be printed on a “For Sale” sign located on the property and/or associated with physical and virtual materials for the property. The short-code may be a code associated with all of the properties of a particular real estate agent. The key word then identifies the particular property that in which a user may have interest.

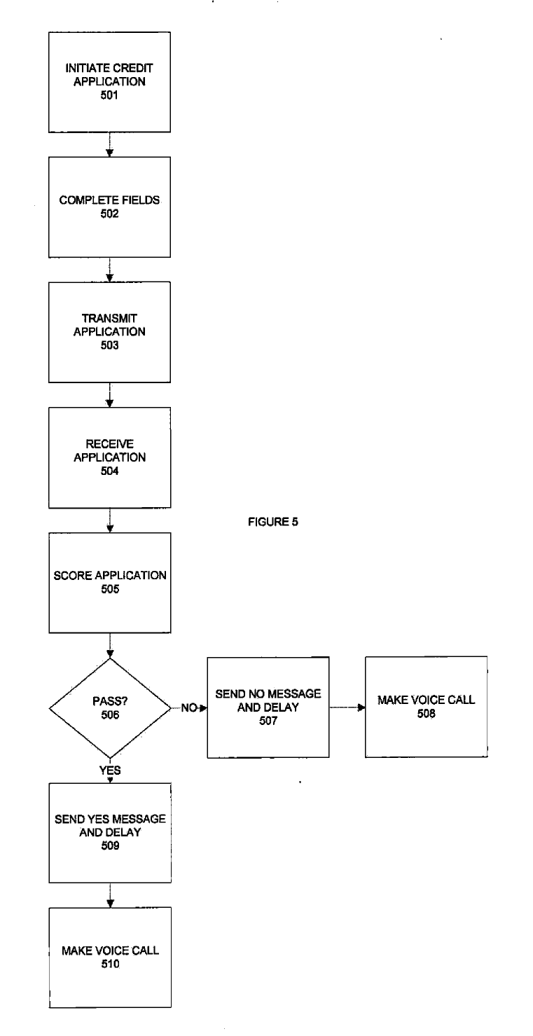

The operation of the system in connection with a real property listing is illustrated in the flow diagram of FIG. 4. At step 401 the system receives a message addressed to the short-code associated with a property. Sometimes a potential buyer is driving through a neighborhood and sees a “For-Sale” sign and wants to get some information immediately. Using this system, the buyer sees the short-code and keyword on the sign and can instantly get information about the property listing.

At step 402 the system retrieves the keyword sent with the message. At decision block 403 the system checks to determine if the key word has an associated listing. If not, the system returns a generic message at step 404 from the agent or brokerage and invites the buyer to get more information by calling or texting. If there is a match, the system proceeds to step 405 and initiates a call to the device from which the text message was sent. When the buyer answers, a pre-recorded message associated with the property is played back to the buyer. In some embodiments, the buyer has a chance to go through one or more nested options at this point, as described in FIG. 3.

At step 406, the system sends a text message with listing details to the buyer's phone. The buyer is then able to check pricing, square footage, and other details and make a decision about whether there might be interest in the property. The listing details can also include contact information of the agent or that contact information may be sent as a separate message. In one embodiment of the system the voice call may be optional and only a text message is sent as a reply.

Credit

In one embodiment, the system is used to process credit requests. FIG. 5 is a flow diagram illustrating the operation of the system in the credit embodiment. At step 501 a user initiates a credit application function. At step 502 the user completes the application. This may be via completing fields on a device, or by providing identifying information sufficient for a credit determination to be made. At step 503 the user transmits the credit application via a short-code and keyword.

At step 504 the system receives the application and scores the application at step 504. The scoring may be done by the system or it may be handled by a third party scoring service. At decision block 506 the system determines if the user has passed or not passed the credit check. In this embodiment, it is desired to have the user know the result of the application via text before receiving the corresponding voice message. If the answer at decision block 506 is no, the system sends a no message to the user at step 507. The system builds in a delay after the message is sent before initiating the voice connection. It is designed to compensate for text message delivery delays as a result of carrier network traffic and to allow time for the user to read the text message before receiving the call. After the delay, at step 508, the voice call is initiated and the message is customized for a user that did not receive credit.

If the answer is yes at decision block 506, the system sends a yes text message to the user at step 509. Again a delay is implemented and a corresponding yes voice communication is initiated after the delay at step 510.

The delay is optional and other embodiments without delay may be implemented as well.

PHONE to SMS

In an alternate embodiment, the system may incorporate a repository accessed via a phone call. In this case the unique identifier is a phone number and/or extension or access code. When the requester calls the number and enters the access code for that user, an automated return text message may be sent to the requester with the contact information. If this system is widely implemented, many people will have an account and most people will know the main access number. The only information needed may be the access code. This access code could also be alphanumeric and take advantage of the letters on the keypad to spell out appropriate user names.

### Example Computer Embodiment

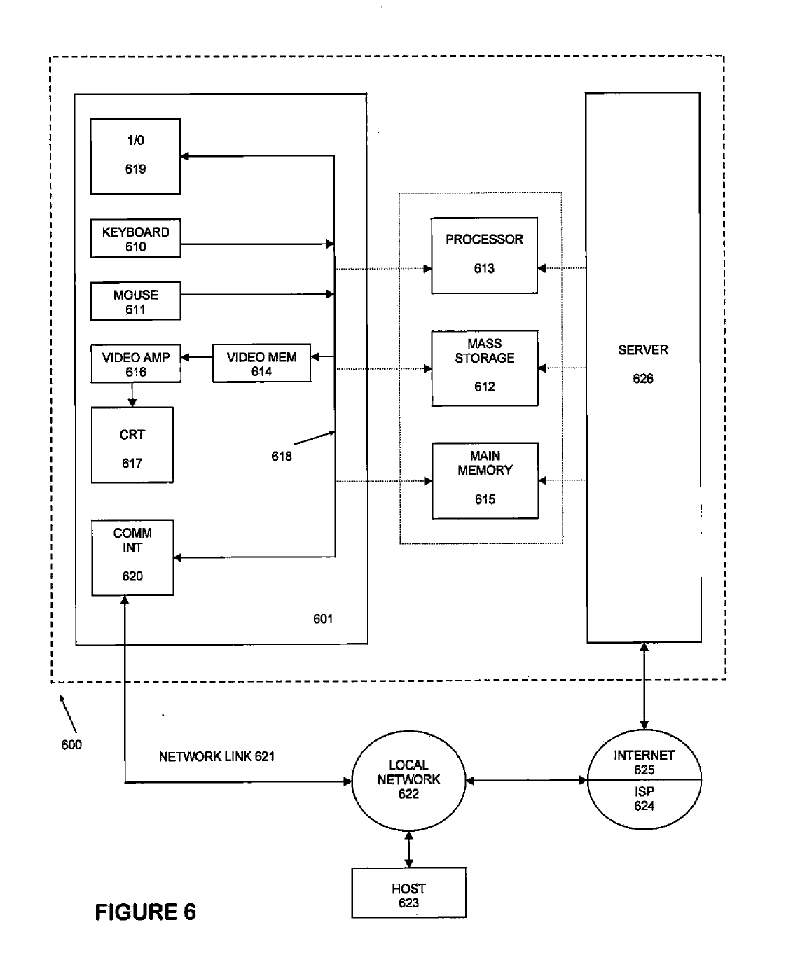

An embodiment of the system can be implemented as computer software in the form of computer readable program code executed in a general purpose computing environment such as environment 600 illustrated in FIG. 6, or in the form of bytecodes running on a processor (or devices enabled to process bytecodes) existing in a distributed environment (e.g., one or more processors on a network). A keyboard 610 and mouse 611 are coupled to a system bus 618. The keyboard and mouse are for introducing user input to the computer system and communicating that user input to central processing unit (CPU 613. Other suitable input devices may be used in addition to, or in place of, the mouse 611 and keyboard 610. I/O (input/output) unit 619 coupled to bi-directional system bus 618 represents such I/O elements as a printer, A/v (audio/video) I/O, etc.

Computer 601 may include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Wireless links are also possible. In any such implementation, communication interface 620 sends and receives electrical, electromagnetic or optical signals which carry digital data streams representing various types of information.

Network link 621 typically provides data communication through one or more networks to other data devices. For example, network link 621 may provide a connection through local network 622 to local server computer 623 or to data equipment operated by ISP 624. ISP 624 in turn provides data communication services through the world wide packet data communication network now commonly referred to as the “Internet” 625. Local network 622 and Internet 625 both use electrical, electromagnetic or optical signals which carry digital data streams. The signals through the various networks and the signals on network link 621 and through communication interface 620, which carry the digital data to and from computer 600, are exemplary forms of carrier waves transporting the information.

Processor 613 may reside wholly on client computer 601 or wholly on server 626 or processor 613 may have its computational power distributed between computer 601 and server 626. Server 626 symbolically is represented in FIG. 6 as one unit, but server 626 can also be distributed between multiple “tiers”. In one embodiment, server 626 comprises a middle and back tier where application logic executes in the middle tier and persistent data is obtained in the back tier. In the case where processor 613 resides wholly on server 626, the results of the computations performed by processor 613 are transmitted to computer 601 via Internet 625, Internet Service Provider (ISP) 624, local network 622 and communication interface 620. In this way, computer 601 is able to display the results of the computation to a user in the form of output.

Computer 601 includes a video memory 614, main memory 615 and mass storage 612, all coupled to bi-directional system bus 618 along with keyboard 610, mouse 611 and processor 613.

As with processor 613, in various computing environments, main memory 615 and mass storage 612, can reside wholly on server 626 or computer 601, or they may be distributed between the two. Examples of systems where processor 613, main memory 615, and mass storage 612 are distributed between computer 601 and server 626 include Internet based personal digital assistants, Internet ready cellular phones and other Internet computing devices, and in platform independent computing environments.

The mass storage 612 may include both fixed and removable media, such as magnetic, optical or magnetic optical storage systems or any other available mass storage technology. Bus 618 may contain, for example, thirty-two address lines for addressing video memory 614 or main memory 615. The system bus 618 also includes, for example, a 32-bit data bus for transferring data between and among the components, such as processor 613, main memory 615, video memory 614 and mass storage 612. Alternatively multiplex data/address lines may be used instead of separate data and address lines.

In one embodiment of the invention, the processor 613 is a microprocessor such as manufactured by Intel, AMD, Sun, etc. However, any other suitable microprocessor or microcomputer may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the cathode ray tube (CRT) raster monitor 617. Video amplifier 616 is well known in the art and may be implemented by any suitable apparatus. This circuitry converts pixel data stored in video memory 614 to a raster signal suitable for use by monitor 617. Monitor 617 is a type of monitor suitable for displaying graphic images.

Computer 601 can send messages and receive data, including program code, through the network(s), network link 621, and communication interface 620. In the Internet example, remote server computer 626 might transmit a requested code for an application program through Internet 625, ISP 624, local network 622 and communication interface 620. The received code maybe executed by processor 613 as it is received, and/or stored in mass storage 612, or other non-volatile storage for later execution. In this manner, computer 600 may obtain application code in the form of a carrier wave. Alternatively, remote server computer 626 may execute applications using processor 613, and utilize mass storage 612, and/or video memory 615. The results of the execution at server 626 are then transmitted through Internet 625, ISP 624, local network and communication interface 620. In this example, computer 601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus a method and apparatus for exchanging information has been described.

What is claimed is:

1. A method for communicating information comprising:
associating information of a first party with a keyword;
providing access to the information to a second party via the second party texting the keyword to a short-code number;
returning information to the second party.

2. The system of claim 1 wherein the information is contact information.

3. The system of claim 1 wherein the information is credit information.

4. The system of claim 1 wherein the information is real estate listing information.

5. The system of claim 1 wherein the information is a record associated with the short-code.

6. The system of claim 1 further including a plurality of records wherein each of the plurality of records is associated with the short-code and its own keyword.

7. The system of claim 1 wherein the information is provided to the second party via a communication.

8. The system of claim 7 wherein the communication is via a text message.

9. The system of claim 7 wherein the communication is via a voice message.

10. The system of claim 9 wherein the communication is via text and voice message.

11. The system of claim 7 wherein the communication includes opt-in options for the second party to access additional information by providing a response.
